(19) United States
(12) Patent Application Publication
(10) Pub. No.: US 2009/0055642 A1
(43) Pub. Date: Feb. 26, 2009

(54) Method, system and computer program for protecting user credentials against security attacks

(76) Inventors: Steven Myers, Toronto (CA); Murray James Brown, Toronto (CA); Donald Craig Waugh, Oakville (CA)

Correspondence Address: BENNETT JONES LLP, 3400 ONE FIRST CANADIAN PLACE, PO BOX 130, TORONTO, ON, M5X 1A4, CA

(21) Appl. No.: 10/870,990

(22) Filed: Jun. 21, 2004

(51) Int. Cl. H04L 9/06

(52) U.S. Cl. 713/155; 380/277

(57) ABSTRACT

A method, system and computer program is provided for protecting against one or more security attacks from third parties directed at obtaining user credentials on an unauthorized basis, as between a client computer associated with a user and a server computer is provided. The server computer defines a trusted Public Key Cryptography utility for use on the client computer. The Public Key Cryptography utility is operable to perform one or more cryptographic operations consisting of encrypting/decrypting data, authenticating data, and/or authenticating a sender, decrypting and/or verifying data. The user authenticates to the Public Key Cryptography utility, thereby invoking the accessing of user credentials associated with the user, as defined by the server computer. The Public Key Cryptography Utility facilitates the communication of the user credentials to the server computer, whether directly or indirectly via an authentication agent, the server computer thereby authenticating the user. In response, the server computer providing access to one or more system resources linked to the server computer to the user. The present invention also provides a series of methods enabling the server computer to authenticate the user by operation of the Public Key Cryptography utility and/or based on enrolment of the user and providing the Public Key Cryptography utility to the user.

### FIELD OF INVENTION

This invention relates generally to the secure authentication of a user using Public Key Cryptography (PKC). This invention relates more particularly to the secure enrollment and generation of client PKC credentials for a client application or a browser, using said credentials to securely authenticate to an application (web) server and protecting client credentials from man in the middle and similar attacks designed to capture user credentials and/or impersonate a user.

### BACKGROUND OF THE INVENTION

One of the fastest growing sources of fraud and identity theft on the Internet circa 2004 is a criminal exploit known as “phishing”. “Phishing” describes generally a variety of different security attacks directed at obtaining user credentials on an unauthorized basis, which user credentials are used to access on-line resources, such as for example an online banking web site. Aided by weak email and client authentication methods, organized crime (“Phishers”) is taking control of customer credit card, bank and fund transfer accounts to their financial gain.

Phishing attacks involve the mass distribution of ‘spoofed’ e-mail messages with return addresses, links, and branding, which appear to come from reputable banks, insurance companies, retailers or credit card companies. These fraudulent messages direct recipients to fraudulent web sites or download malicious software, which are designed to fool the recipients into divulging personal authentication data such as account usernames and passwords, credit card numbers, social security numbers, etc. Because these emails and web sites look “official”, recipients may respond to them providing their user credentials (typically username and password) resulting in financial losses, identity theft, and other fraudulent activity.

Phishing attacks involve an ever-expanding array of technical exploits. Phishing criminals are becoming increasingly sophisticated and are using software developed by virus writers and spammers for their exploits. The following outlines some of the methods currently deployed.
Counterfeit Web sites appear to be a targeted entity such as an institution
   Phishers are able to steal web site content and images and create counterfeit web sites that have virtually the same appearance as a real web site, thereby fooling the reader into believing that they are on the actual web site.
   To further the ruse, Phishers register domain names that are a typical misspelling of a target domain name or are similar in sound or extension of the target name such as security, Citibank.com.
Browser URL flaw in Internet Explorer
   “%00” before the host name is used to hide the counterfeit host and display the target web site URL. It is superior to registering domain names in that the Phishers can use the IP address of the counterfeit host and substitute the IP address for the target URL domain name further fooling the user that they are on the correct web site.
   This has been corrected in a newer version of Internet Explorer, but this version is not used universally.
JavaScript replaces URL with Jpeg or Gif image
   A standard feature of a web browser allows menus and URL displays to be closed by the user. To automate this, Phishers use a Java script to detect the browser and then send the appropriate command to the browser to close the URL display. Once closed down, the JavaScript replaces the closed display with an image that looks like the URL display, and which includes the correct domain name of the target institution.
JavaScript replaces SSL with JPEG or GIF image
   The same URL spoofing technique can be used to display the SSL lock or key which is supposed to authenticate the target web site and establish a secure channel. Replacing this with the an image offers the user a false sense of security that they have connected with the target institution
Defaults to text based SSL causing browser to display the SSL lock
   One of the SSL encoding methods is ‘plain text.’ Most SSL servers have this disabled by default, but most browsers support it. When plain text SSL is used, no central certificate authority is consulted and the user never sees a message asking if a certificate should be accepted (because ‘plain text’ doesn't use certificates). The SSL “lock” or “key” icons will display but will not authenticate the web site certificate and may even leave the channel unencrypted.
Java proxy mirrors targeted institution web site.
   An email is sent that sends the victim to a server on the web that uses JAVA to turn the machine into a proxy like system. The other end of the proxy is the financial institution's website (for example). The victim actually is looking at the real website of the institution they may have an account on. When the user logs in, the “PROXY” site collects the information and the crackers use it at another time. The victim can log on to their account and do anything they want, but all activity is logged.
Counterfeit Phishing web site opens target web site simultaneously
   This technique opens two web pages simultaneously, one is the authentic web site and the second is the counterfeit web site. The counterfeit web site does not display an URL, which is typical of pop-up windows and relies on the URL of the authentic web site to fool the user.
   The counterfeit web site also includes links to the authentic web site further fooling the user.
Phisher temporarily hosts open proxies for counterfeit web sites
   Home users' “always on” broadband connected unprotected personal computer (no firewall) become open proxies facilitating IP hopping which allow Phishers to launch phishing attacks. They attack from multiple systems using IP hopping techniques to fool Phishing blocks or host shutdown attempts. Phishing exploits are able to hop at specified intervals matching temporary IP addresses to Phishing email links making it difficult for authorities to shutdown phishing exploits as they emanate from temporary and multiple sources.
Key logger downloaded captures user login credential
   Users inadvertently download key logger SPYWARE™ delivered by email, from a web site or via applications such as music sharing services such as KAZAA™ or by P2P (person to person) software such as MSN Messenger™ or ICQ™. Once downloaded, key loggers capture the user's key strokes which can include usernames and password to capture user credentials
Trojan remotely reports user activities to capture user credentials
   Applications such as the “BUGBEAR B” worm spread via e-mail as a file attachment that can be launched via the IFRAME™ breach in the INTERNET EXPLORER™ security system (which starts the worm upon message opening), or manually when a user opens the infected file attachment allowing the virus's creator to control infected machines and gain access to confidential information. The ROYAL BANK OF CANADA™ had funds stolen from customers via this mechanism, as was publicized.
Trojans have capabilities to allow remote control of user's desktop
   W32/Mofei-A is a worm which spreads via network shares and contains a backdoor Trojan which allows remote access and control over the computer. When W32/Mofei-A is run on MICROSOFT™ Windows NT™, 2000™ or XP™, it replaces the “Smart Card Helper” service and configures this service to run automatically upon startup, thereby allowing Phishers to take control of any application on the users desktop.
Trojan “Man in the middle” exploit establishes SSL connection
   With this exploit a Phisher, “man-in-the-middle” performs the SSL negotiation with the legitimate server using its keys, and the victim is doing SSL negotiation with the man-in-the-middle using the man-in-the-middle's key (which the user believes is the legitimate server's key). As far as both parties are concerned, they are talking to legitimate clients/servers. Neither the legitimate server or the victim are likely to become aware of the attack,
Trojans designed to steal client private keys and credentials
   What the user sees is not necessarily what is actually happening on the user's system. In this exploit, the Trojan interjects between the application and the WINDOWS™ CSP (Cryptographic Service Provider) allowing the Phisher to take control, and in some cases steal, the private keys and credentials of the user. To the user mental model [DON—WHAT DO YOU MEAN HERE?] is not representative of the actual system's behavior. the underlying assumption that all of the system's components are trusted,
Hidden Browser frames present the bona-fide bank web site
   With this exploit the Phisher opens the target web site within a browser frame. The Phisher's frame can be set to zero with no border such that the user cannot detect it. The Phisher's frame harvests the user credentials as they are being entered into the target web site.

One of the reasons why the above attacks are commonplace is because username and password is the dominant method in use today for customer authentication. It is the simplest and cheapest method for client authentication. Unfortunately, it is also a relatively weak form of security, and relatively susceptible to these attacks. By way of example, to sign into an online bank or similar web site, a user simply provides their username and password to sign in. These can be easily stolen and is the root cause behind the criminal success of Phishing.

Secure Sockets Layer (SSL) v2 and v3 and Transport Layer Security (TLS) protocols were created to provide security for web based applications. The protocols allow client/server applications to communicate in a way that is designed to prevent eavesdropping, tampering, or message forgery.

The SSL protocol allows mutual authentication between a client and server and the establishment of an authenticated and encrypted connection. SSL runs above TCP/IP and below HTTP, LDAP, IMAP, NNTP, and other high-level network protocols. It was originally invented by NETSCAPE™ and has become a de facto Internet standard. For the SSL 3.0 specification (also called SSL v3) in plain text form, see http://www.mozilla.org/projects/security/pki/nss/ssl/draft302.txt

TLS is a protocol from the IETF (Internet Engineering Task Force) based on SSL. It will eventually supersede SSL while remaining backward-compatible with SSL implementations. For the version 1.0 of the TLS protocol specification, see http://www.ietf.org/rfc/rfc2246.txt

The following documents provide background information regarding the technology behind SSL/TLS:

This document explains the basic concepts of public-key cryptography. http://developer.netscape.com/docs/manuals/security/pkin/index.htm

This document introduces the SSL protocol, including information about cryptographic ciphers supported by SSL and the steps involved in the SSL handshake. http://developer.netscape.com/docs/manuals/security/sslin/index.htm

Server based SSL/TLS is used to authenticate the web site a user is connecting to. It is the dominant implementation of SSL/TLS used on the Internet today. With SSL/TLS, PKI certificates are issued to companies to embedded in their web servers so as to allow browsers to authenticate the web site. Once authenticated, the browser displays a lock or key indicating that the session is secure. However, experience has proven that users typically do not verify the web site certificate and therefore it is easy to fool the user to believe that they are secure as evidenced by the previously explained security attacks. Consequently, with either simple authentication or server based SSL authentication, generally all that is required is a username and password, which makes stealing client credentials easy to accomplish.

To enhance SSL/TLS based security, most browsers support client side authentication. Client side SSL/TLS involves two-way authentication where both the web server and the browser client are issued PKI certificates. These certificates are used to mutually authenticate each other. Unfortunately, the way in which client side SSL was developed leaves the client open to attack in a number of ways. Attack methods allow Phishers to, in the worst case, capture the client certificate and private keys and, in a variety of ways, control SSL client credentials allowing Phishers to impersonate a client in an SSL session. For a detailed review of some of the ways in which this can be accomplished see Keyjacking:

The Surprising Insecurity of Client-side SSL http://www.cs.dartmouth.edu/˜sws/papers/keyjack2.pdf

Because of weak authentication methods “Phishing Criminals” send out decoy emails and/or Trojans, which are designed to fool customers into providing their username and password or client credentials, which once captured, allows the Phisher to take control of the user's account and use it to their financial gain.

Other prior art solutions exist for minimizing the impact of the aforementioned security attacks. For example, most Phishing attacks can be solved by two-factor authentication. Two-factor authentication consists of using two elements for authentication, such as a password and a token. However, the more insidious and sophisticated attacks such as those that allow the Phisher to remotely control the user's applications or steal user credentials and private keys are not generally adequately addressed by two-factor authentication. These types of Phishing techniques utilize software that is designed to hook into or take control of the user's application software or operating system software. A “hook” is a mechanism that allows for the interception and even a behavior modification of a function or section of code. For example, one of the exploits for capturing user private keys and credentials hooks function calls between the user browser and certificate store, on the one hand, and the CSP (Crypto Service Provider) on the other, such that the hook is able to capture or control the user's credentials. Similarly, Trojans as well as commercial software is available to remotely control a user's personal computer such that the Phisher can remotely log in to target web sites impersonating the user, by using the user's personal computer.

Anti-hook software that can identify such hooks or remote control through a number of techniques to prevent such actions is known. Such techniques include:
Anti-hook software preventing hooks from interfering with the input process by running an “Anti-Hook”/“Hook Blocker” daemon when the Authentication login dialog is active.
A Localized resource, which detects unauthorized use of the resource.
Checking fingerprints of files for matching to a Trojan database.
Checking fingerprints of a running process to match to a Trojan database.
Checking for programs automatically started on a system boot.
Checking for open virtual ports.

The disadvantage of prior art hooking solutions is that new hooking techniques are often developed, such that anti-hooking techniques are one step behind the Phishers. Also, the anti-hooking techniques often do not address one or more of the other security attacks discussed above. Another disadvantage of the prior art solutions is that they require entities (such as for example financial institutions) to adopt new processes or technologies, whereas significant inertia exists to depart from such processes or technologies because of investments in technology or familiarity of users with existing processes or technologies such that change may cause user retention problems.

Another technique consists of using a “Progressive Trust Module”. In one particular implementation of this prior art solution, once a customer has upgraded to secure two factor authentication, customer usage patterns are monitored by the Progressive Trust Module that compares current activity to historical activity. With the Progressive Trust Module, trust is progressively established over a period of time. Activity that falls outside typical activity patterns allows the host institution to elevate monitoring and investigate the specific user activity and potentially catch a Phishing attack. The disadvantage of this prior art solution is that the Progressive Trust Module trust is not immediate and Phishers will have to transact in typical user patterns for a period of time before being able to steal funds from a user account making this type of Phishing attack more difficult to accomplish, but still possible.

What is therefore required is a system, method and computer program that allows customers to authenticate to on line web applications securely and which prevents criminals from stealing client credentials and impersonating them. What is further required is a system, method and computer program that allows application servers to control client authentication using more secure authentication techniques that allow the application server to detect or prevent impersonation.

### SUMMARY OF THE INVENTION

The system, method and computer program of the present invention enables users to enroll in and generate personal PKC credentials and use these credentials to authenticate to a web application or an on line service. The system, method and computer program of the present invention further protects the user credentials such that they are protected from use by a malevolent third party attempting to impersonate the user.

From the user's perspective the system, method and computer program of the present invention is designed to make the enrollment and authentication process work in a way which is simple, easy and very similar to present authentication mechanisms that they are familiar with, such that the user is not unduly burdened or challenged to enroll in or authenticate using PKI.

In one aspect thereof, the present invention permits recipients to enroll in and generate private PKC keys and digital certificates for authenticating to a server securely in a hostile environment.

In another aspect of the present invention, recipients are given access to private PKC keys and digital certificates for authenticating to an application or web server.

In yet another aspect of the present invention, recipients are permitted to use temporary or unpredictable code words so as to access web applications from any network-connected device in a manner that eliminates the need for location specific private key and digital certificate storage.

### BRIEF DESCRIPTION OF THE DRAWINGS

A detailed description of the preferred embodiment(s) is(are) provided herein below by way of example only and with reference to the following drawings, in which:

FIG. 1 is a schematic System Architectural Component Diagram of the secure enrollment and authentication system of the present invention.

FIG. 1a is a program resource chart illustrating the resources of the application of the present invention, in one embodiment thereof.

FIG. 1b is a program resource chart illustrating the resources of the application of the present invention, in another embodiment thereof.

FIG. 2 is a flow chart that depicts the steps in enrolling in a PKI and generating and storing PKI keys and certificates using a client or a browser based in accordance with one aspect of the method of the present invention.

FIG. 3a is a flow chart that depicts the steps for authenticating a user to an application server by digitally signing a message from a server and optionally using a credential presentation agent in accordance with one aspect of the method of the present invention.

FIG. 3b is a flow chart that depicts the steps for authenticating a user to an application server using a cryptogram and optionally using a credential presentation agent in accordance with one aspect of the method of the present invention.

FIG. 3c is a flow chart that depicts the steps for authenticating a user to an application server using SSL/TLS and optionally using a credential presentation agent in accordance with one aspect of the method of the present invention.

FIG. 3d is a flow chart that depicts the steps for authenticating a user to an application server using a trusted component, a secured session and password authentication and optionally using a credential presentation agent in accordance with one aspect of the method of the present invention.

FIG. 3e is a flow chart that depicts the steps for authenticating a user to an application server using a temporary and unpredictable code word for authentication and optionally using a credential presentation agent in accordance with one aspect of the method of the present invention.

FIG. 4 is a flow chart that depicts the steps for a user to cancel authentication credential(s) in accordance with aspects of the method of the present invention.

### DETAILED DESCRIPTION OF THE PREFERRED EMBODIMENT

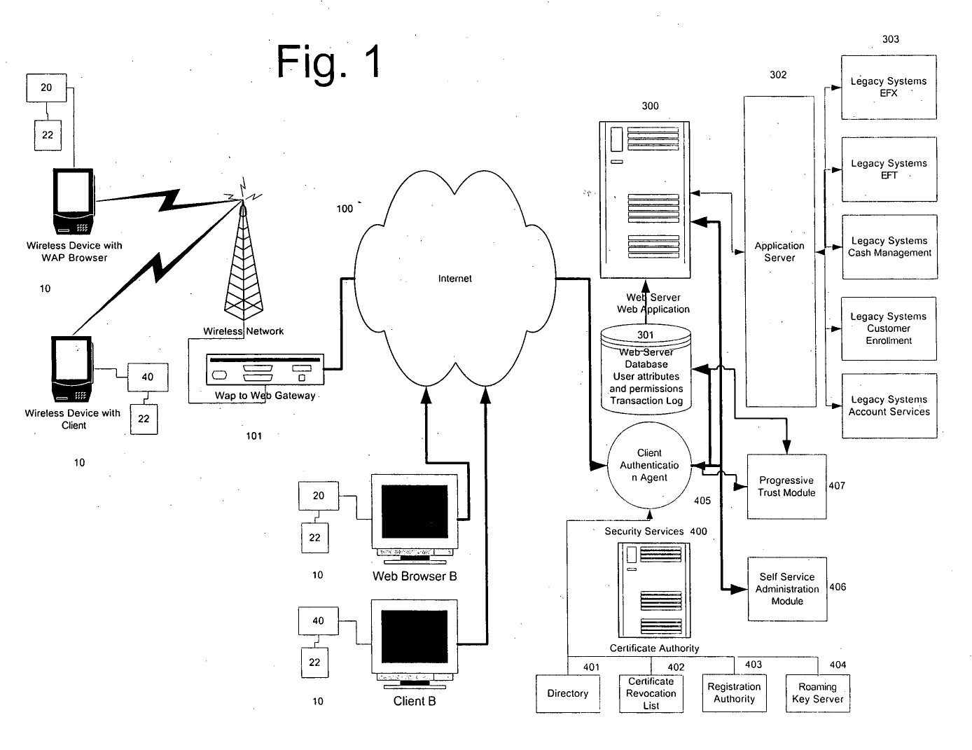

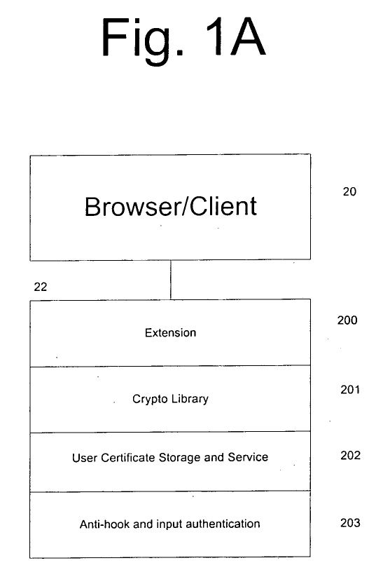

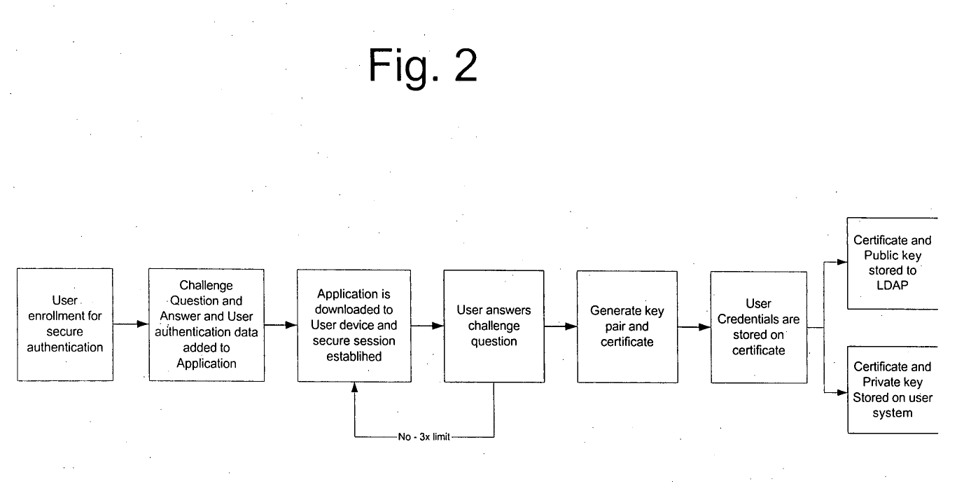

As illustrated in FIG. 1, at least one known network-connected device 10 is provided. Network-connected devices 10 may consist of a number of digital devices that provide connectivity to a network of computers. For example, the network-connected device 10 may consist of a known personal computer or a known WAP device, cell phone, PDA or the like.

The network-connected device 10 is connected to the Internet 100 in a manner that is known. Specifically in relation to FIG. 1, the connection of a network-connected device 10 that is a known WAP device to the Internet is illustrated, whereby a known WAP to WEB gateway 101 is provided, in a manner that is also known.

Also as shown in FIG. 1a, each of the network-connected devices 10 may include a known computerized device, which includes the browser/client application 20. The browser can be a standard Internet based browser, such as Netscape's NAVIGATOR™ or Microsoft's INTERNET EXPLORER™ or a known mini browser for wireless devices such as cell phones or PDAs. Client application can be a known client program such as a personal banking program or another known program for wireless devices such as cell phones or PDAs, including those commonly bundled in such devices as part of the devices' operating system or is distributed as a separate component. The client application can also be a custom client or custom browser used for secure applications.

Each of the network-connected devices 10 also includes the application 22 of the present invention, which consists of the computer program of the present invention. The application 22 is best understood as a PKC utility, as particularized in this disclosure. Certain attributes of this application 22, in particular the manner in which it permits Public Key Cryptography (PKC) enabled communications over wired and wireless networks is disclosed in U.S. Pat. No. 6,678,821 issued to Echoworx Corporation and the Co-Pending patent application Ser. Nos. 10/178,224, 10/379,528 and 10/843,319 (the “Patent” or the “Co-Pending Patent Applications”, as applicable).

As particularized below, the application 22 includes a Crypto Library 201 or PKC crypto utility. In one particular embodiment of the application 22, illustrated in FIG. 1a, the application 22 consists of a specialized extension 200 or plug-in. Specifically in one embodiment of the invention, the application 22 and the browser/client application 20 inter-operate by means of, for example, customized HTML tags for a browser or for example, customized programming specific to the client application. Application 22 preferably provides the necessary resources to enable the network-connected device 10, as particularized below, to function with any third party PKI system, including for example, ENTRUST™, MICROSOFT™, BALTIMORE™, RSA™CERTICOM, DIVERSINET and so forth. It should also be understood that the functions of the application 22 described herein can also be provided as an “ACTIVE X OBJECT” in a manner that is known, or integrated directly into a browser/client application 20.

Application 22 functions as a cryptographic utility, provided in the manner described in the Patent and Co-Pending Patent Applications, such that the application 22 is adapted to perform at the network-connected device 10 one or more of a series of cryptographic operations, including but not limited to:
Digital signature of data such as Secure Hash Algorithm version (“SHA”) SHA1 and Message Digest Version 2 (“MD5”)
Encryption of data; Advanced Encryption Standard (“AES”),
Data Encryption Standard (“DES”); DES3,
Rivest-Shamir-Adleman (“RSA”),
Elliptic Curve Cryptography (“ECC”)
Decryption of data; AES; DES; DES3; RSA; ECC
Verification of signature of data; SHA1 and 2 MD5
Creation of cryptograms; Extensible Markup Language (“XML”) or Hypertext
Markup Language (“HTML”) documents
Creation of certificates and PKC key pairs RSA, ECC
Encryption or decryption of files
Diffie Helman Key Exchange
Augmentation of certificates with encrypted user data
Management of certificates and certificate data

Specifically, application 22 includes a Crypto Library 201, provided in a manner that is known. In one particular embodiment of the present invention, the application 22 also includes a User Certificate and Private Key 202 which contains the cryptographic data required to encrypt and/or digitally sign data or decrypt and verify data and data communications to facilitate mutual authentication as contemplated by the present invention. For example, in one particular implementation of the present invention, namely one whereby MICROSOFT™ software provides the Security Services 400, the .PFX or DER (Distinguished encoding rules ASN.1) encoded X509 certificate files required to authenticate the application server, or encrypt data for the recipient, are downloaded to the network-connected device 10 or are generated by the network-connected device 10. The .PFX file is an encrypted file that is used to access the user credentials and private key required to process cryptographic operations. The PFX file is formatted based on the PKCS12 standard. The DER encoded X509 certificate file provides the public key and certificates of the recipient and in one embodiment of the invention the X509 Certificate includes application account user ID and password information that is encrypted for the application and in another embodiment is further encrypted for the certificate owner with such encrypted information stored on the X509 certificate in the extension fields.

Security Services 400 should be understood as a general term describing a known PKI infrastructure. PKI infrastructures can vary as to the particulars of their architecture, or their hardware or software components. Typically, however, a PKI infrastructure consists of the components illustrated in FIG. 1: a Certificate Authority for issuing and certifying certificates for enrolled users; a registration authority for enrolling users; a Lightweight Directory Access Protocol directory (or “LDAP”) for storing the public keys and certificates of enrolled users; and a Certificate Revocation List (or “CRL”) for revoking certificates. In another aspect of Security Services 400 also illustrated in FIG. 1, a Roaming Key Server (or “RKS”) is used for storing private keys of enrolled users. In another aspect of Security Services 400 also illustrated in FIG. 1, a user Credential Administration Module of Self-Administration Module is provided for user self-service. As stated earlier, application 22 of the present invention includes a PKC extension as described below. The PKC extension permits the encryption and decryption of data communications in a browser or client, as particularized herein. This has the advantage of broad-based deployment as browser technology and client software is commonplace. This also has the advantage of deployment across wireless and wired networks as the application 22 of the present invention, including the browser/client extension 20, can be associated with a web browser or a WAP browser, as shown in FIG. 1a. In addition, the invention disclosed herein requires only a browser or a client and the associated application 22 at each network-connected device 10 rather than developing a custom secure client at each network-connected device 10 which reduces the resources required at each such device to provide PKI functionality.

The application 22, and its components, are generally reduced to code in a manner that is known. However, it is desirable for the browser/client application 20 (or other corresponding elements based on further implementations of this function of the application 22) to have a number of attributes. However, it should be understood that these described features are not essential, so long as the browser/client extension 20 is provided in a manner that conforms to good security practice. The attributes listed below provide an example of security features of a representative browser/client application 20 of the present invention. It should be understood that the browser/client application 20 is also referred to as the browser/client extension 20, which is one implementation of the present invention, because the invention is often best understood by reference to an “extension” to an existing application, i.e. a browser program or a client program.

First, as a result of the method of the present invention, it is desirable that the browser/client extension 20 be able to enroll and generate a certificate(s) and public key pair(s) for the user. In a preferred embodiment of the invention the browser/client extension 20 shall utilize a secret that is shared between the user and the application server 300 such that the secret is used to authenticate the user and to ensure that there is a direct connection between the extension 200 and the registration authority 403 during enrollment and key and certificate generation as this will help eliminate the potential for a man in the middle attack.

Regarding the application server 300 it should be understood that while the disclosure generally refers to the application server 300 throughout, although the application server 300 is one implementation of a server computer that authenticates the user, in accordance with the present invention. The application server 300 generally includes a known web server, and provides access to a variety of system resources, directly or indirectly, where security is a concern. It should be understood that the present invention contemplates the use of varies client/server architectures, hardware configurations and software utilities.

Second, the key generation, security, and the encryption and decryption of data described herein involve a potential security risk if the browser extension 309 or client extension 409 is not designed properly. Specifically, it is necessary to ensure that browser memory is (in the case of the browser extension 309) utilized in the course of the cryptographic operations such that security is not compromised. In one particular embodiment of the present invention, this is achieved by using the “TEMP” memory space of the browser/client application, in a manner known by a skilled programmer. The browser extension 309 or client extension 409 further includes a CLEANUP ROUTINE or equivalent provided in a manner that is known that eliminates any remnants from the memory associated with the browser, or client, or otherwise with the network-connected device 10, of either the transaction message, the user credential or private key that is part of the User Certificate and Private Key Store 302, in order to maintain confidentiality. Specifically, for example in relation to the browser extension 309, the browser extension 309 is configured such that it will not store a copy of the transaction message in the browser cache. In addition, the browser extension 309 or client extension 409 will delete any copies of any attachments associated with the transaction message.

Thirdly, to protect against “man in the middle” devices, Trojans, System monitors and cookies designed to steal client credentials or to remotely control the user computer, the browser/client extension 20 can optionally include Anti-hook and input authentication capabilities (as described above) that would guard against such malicious applications. The browser/client extension 20 protection can also include Browser IP reporting which would facilitate reverse IP lookup and geographic positioning further enabling system monitoring to identify or mitigate the potential for, such exploits and attacks.

Fourth, to facilitate authentication to existing systems, rather than change established client authentication architectures the browser/client extension 20 can optionally include user authentication credentials such as username and password and store such credentials securely either in the browser/client extension 20, on the certificate or on a server side credential store.

Fifth, to facilitate integration with existing transaction authentication systems such as developed by EURPOAY™, MASTERCARD™ and VISA™, known as the 3-D Secure standard, which is commercially known as VERIFIED™ by VISA or MASTERCARD SECURE CODE™ and similar methods for authenticating users on payment systems such as the Secure Electronic Transaction (“SET”) standard, the browser/client extension 20 will facilitate the creation of cryptograms and similar secure messaging standards for authentication and securing standards based transactions.

Sixth, it is desirable to facilitate the cancellation by the user of the user's authentication credentials and optionally user, location specific, user authentication credentials. One aspect of the present invention is that it enables the user to authenticate securely to an application from multiple locations. The present invention contemplates providing the user the ability to cancel location specific authentication credentials. Normally, only single PKC keys pairs are issued to users. An aspect of the present invention optionally allows multiple key pairs to be issued to users, one pair for each access location, thus allowing the user to cancel one location but continue to access the application server 300 from another location. This is particularly useful in situations where an employee is fired or otherwise terminates their employment. This aspect of the invention will allow the user to remotely disable the cancelled location from authenticating to the application server 300 regardless of whether the user's password is correctly used from that location.

Seventh, to facilitate trust, a Progressive Trust Module (further detailed below) enables the monitoring of user transactions in order to create and maintain trust. When the user enrolls into the system of the present invention, trust is established based on the integrity of the enrollment process and the user involvement. While the present invention provides a beneficial level of security, it does not guarantee that the system cannot be undermined. To further protect against identity theft, the browser/client extension 20 is also linked, in a particular embodiment of the present invention, to a Progressive Trust Module. The Progressive Trust Module monitors user transaction activities against historical user activities and identifies user behavior which deviates from normal activity and escalates such deviations to heighten security monitoring and to potentially contact the client should the situation warrant investigation.

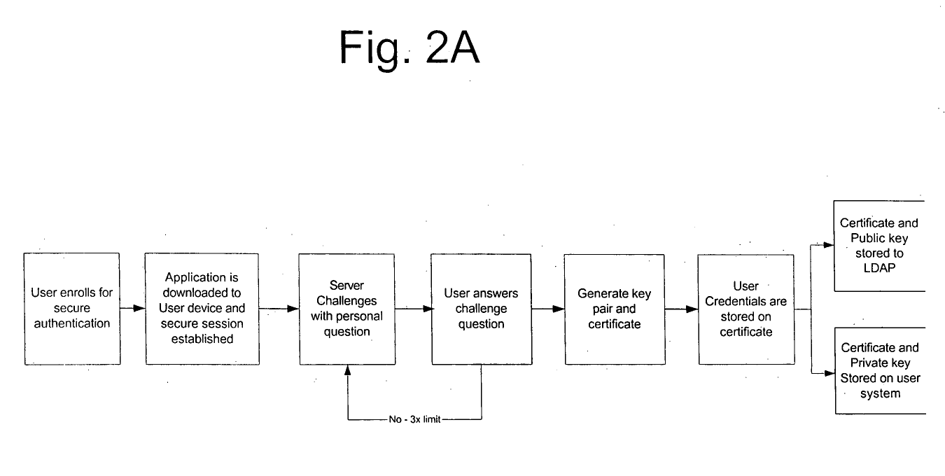

As stated earlier, the present invention also contemplates that the browser/client extension 20 provides means to utilize a shared secret that will be used by the browser/client extension 20 to enroll a user to use the secure authentication system and to generate private and public key pairs and certificate for use by the user. This particular aspect of the present invention is illustrated in FIG. 2.

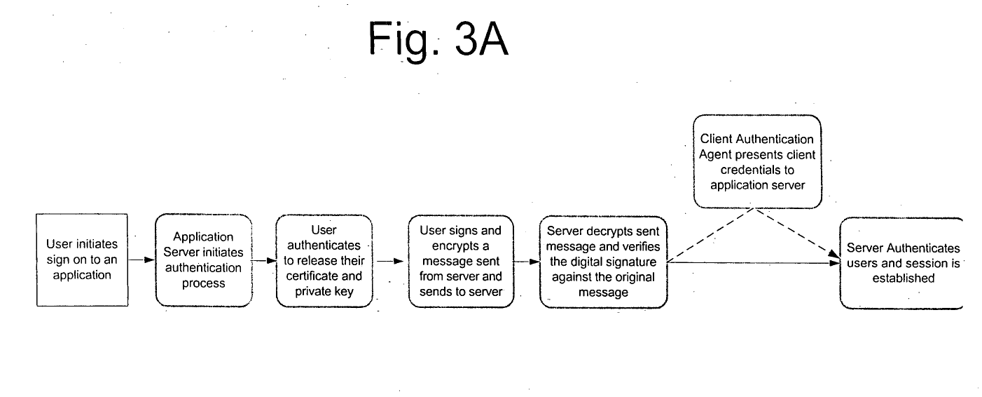

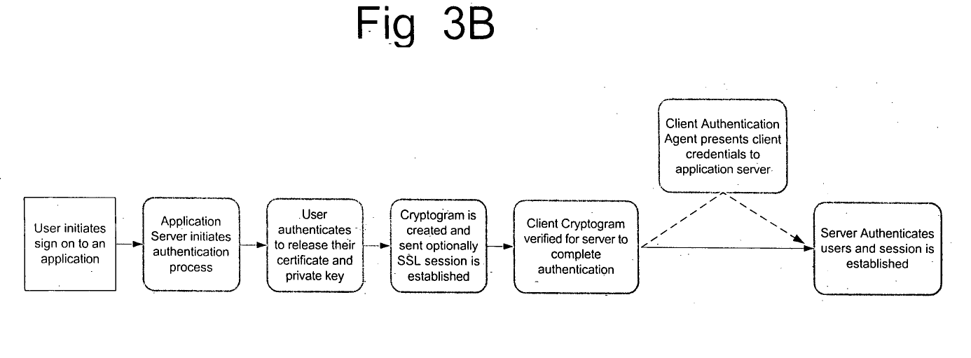

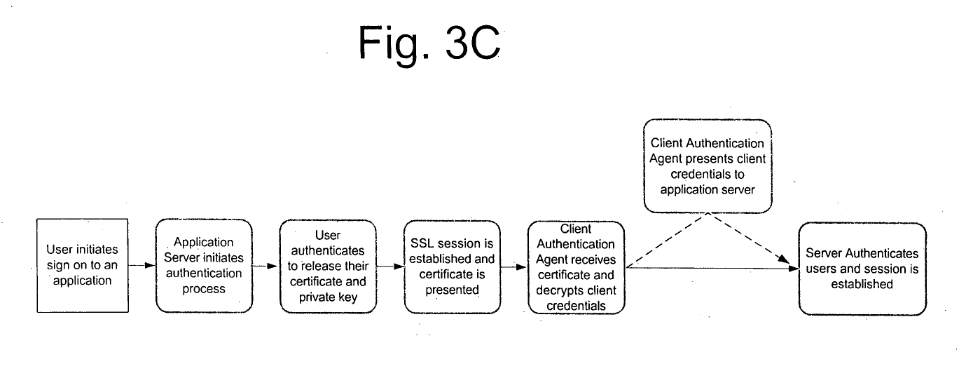

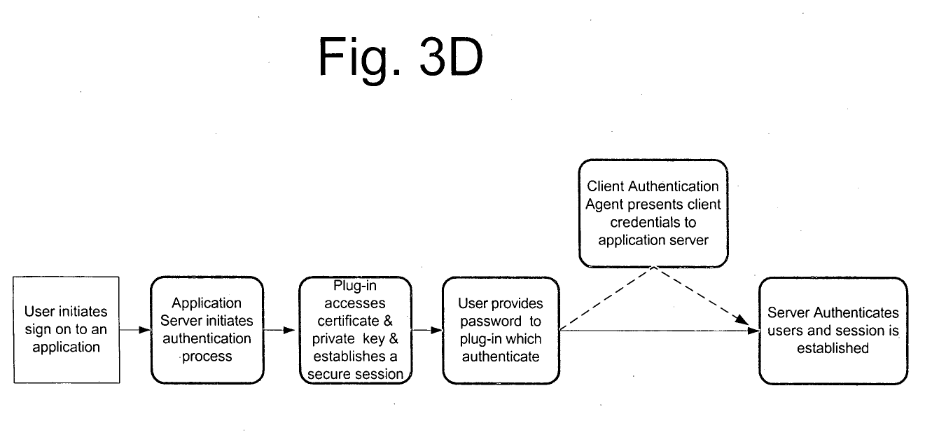

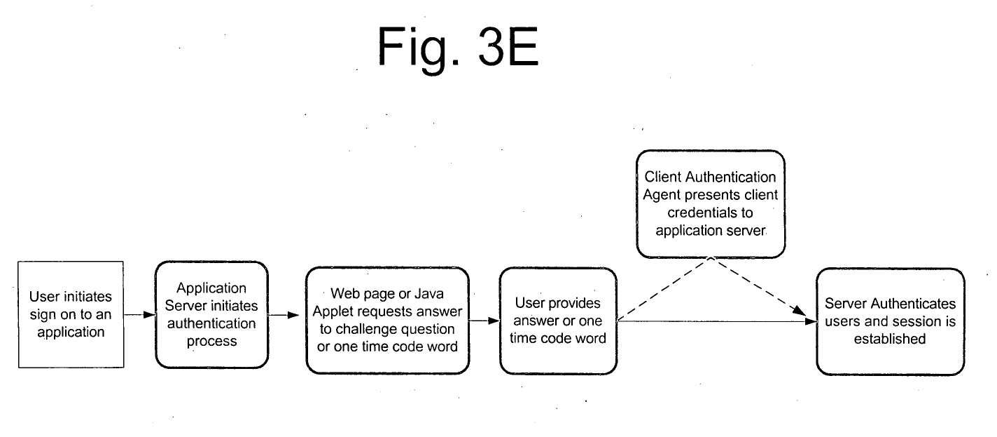

In addition, the present invention contemplates that the browser/client extension 20 facilitates the authentication of the user to a web application server. More particularly, the browser/client extension 20 is adapted to permit the user authenticate in a variety of ways as detailed in FIGS. 3a, 3b, 3c, 3d and 3e.
1. As depicted in the various Figures, the browser/client user can authenticate to an application server by operation of the following processes: the user authenticates using a message sent from the application server which can include the provisioning of:
   (a) user authentication credentials from the browser/client extension 20; and
   (b) user authentication credentials from a server side client credential authentication agent;
2. The user authenticates by creating a cryptogram for the application server 300 which can include the provisioning of:
   (a) user authentication credentials from the browser/client extension 20; and
   (b) user authentication credentials from a server side client credential authentication agent 405.
3. The user authenticates by creating a SSL/TLS session with the application server 300 which can include the provisioning of:
   (a) user authentication credentials from the browser/client extension 20; and
   (b) user authentication credentials from a server side client credential authentication agent 405.
4. The user authenticates by creating a secure session between the browser extension 309 and the application server 300 which can include the provisioning of:
   (a) user password credentials from the browser/client extension 20; and
   (b) user authentication credentials from a server side client credential authentication agent 405.
5. The user authenticates to an application server by using a temporary and unpredictable code word(s) for authentication and optionally using a credential presentation agent.

Also connected to the Internet 100, is an application server 300 (in some cases for the sake of better understanding referred to as a web application server 300) that is provided using known hardware and software utilities so as to enable provisioning of the network-connected device 10, in a manner that is known. The web application server 300 can include a banking or similar bank end application 302. The web application server 300 is adapted to execute the operations, including PKI operations, referenced below.

The system, computer program and method of the present invention are directed to:
1. Enrolling and generating user PKC credentials and key pairs using Security Services 400
2. Authenticating users to the web application using a client authentication agent 405 to authenticate to the Web Server Database 301 or directly to the web application server 300 or to the web application server 300.
3. Creating secure cryptograms and other documents such as XML documents authenticating the user and the transaction of the user Web Server Database 301 or directly to the web application server 300 or to an application server connected to the web application server 300, in a particular implementation of the present invention.

In order to achieve the foregoing, the system, computer program and method of the present invention rely on aspects of the Patent and the Co-Pending Patent Applications for engaging in PKI enabled transactions. Specifically, authentication and authentication messages are created and delivered in accordance with the present invention in a manner that is analogous with the “POSTING DATA ON A SECURE BASIS” and “SECURE DELIVERY OF S/MIME ENCRYPTED DATA” described in the Co-Pending Patent Applications. An email message is retrieved and deciphered in the manner described under the heading “RETRIEVING OF DATA ON A SECURE BASIS” and the “SECURE RECEIPT OF S/MIME ENCRYPTED DATA” also described in the Co-Pending Patent Applications.

### Browser/Client Based Key and Certificate Generation for Non-Enrolled Users

FIG. 2 illustrates the functions of the enrollment utility of the present invention, which embodies the enrollment process of the invention. The main function of the enrollment utility and the related enrollment process is to generate a key pair and a certificate for users to acquire the necessary PKC credentials to authenticate to the application server 300. It should be understood that one of the aspects of the present invention, is that the browser/client application 20 facilitates this enrollment process.

In one particular aspect of this enrollment process, the browser/client application 20 is prepared by the application server 300 for the user. A challenge question and the secret answer, associated with the user, is embedded in the browser/client application 20 for the user. The user then downloads the browser/client application 20 from the application server 300.

Upon the completion of the installation of the browser/client application 20, the browser/client application 20 establishes a mutually authenticated, secure session (possibly using SSL/TLS) between the browser/client application 20 and the application server 300 and the registration authority 403. Upon the establishment of the secure session the browser/client application 20 prompts the user to respond to the challenge question. If the user correctly answers the challenge question the browser/client application 20 allows the enrollment to proceed. It should be understood that the sub-process of presenting the challenge question and obtaining the correct answer can either occur as a function of the browser/client application 20, or as a client/server interaction as between the browser/client application 20 and the application server 300.

In one particular implementation of the invention, the PKC credentials are embedded in the browser/client extension 409, such that the user authenticates to the browser/client extension 409 (or effectively the browser/client application 20 as particularized below).

The application server 300 can optionally add user authentication information such as username and password to the certificate, with such information being optionally encrypted for the client authentication agent 405 to the browser/client extension 409. With embedding of the user information, the browser/client application 20 is then downloaded to the user network-connected device 10.

The challenge is used for enrollment so that the man in the middle would have no previous access to or knowledge of the response, in one particular implementation of the present invention. Consequently, to steal the credentials the man in the middle must sign into the server application posing as the recipient to conduct the upgrade and at the same time cause the recipient to participate in the upgrade process whereby the man in the middle relays the challenge question to the user causing the user to respond to the question and then the man in the middle physically types in the answer to the challenge question into the browser/client application 20. Therefore to develop the ability to invoke a security upgrade requires the user to participate in the credential capture process and for the man in the middle to manually enter the challenge response in real time. Because present Phishing systems use mass emailing techniques to lure users and automated techniques to capture user authentication data, the logistics of real time user participation, real time manual entry of data, anti hook and reverse IP geo-referencing would make phishing attacks extremely difficult and costly to deploy against this approach.

When the browser/client application 20 allows enrollment to proceed, a PKC key pair and a user certificates preferably X509, are created in a manner which is well known.

With the creation of the user certificate, the browser/client application 20 can optionally add user authentication data to the extension fields of the X509 certificate with such user authentication data being optionally encrypted using the user's public key. To be clear, the user authentication data (that is used to authenticate to the application server 300 and not to the key) is optionally encrypted with the key of the operator of the application server 300 and/or the key of the user.

During the completion of the creation of the key pair and certificate, the private key and certificate of the user is stored on the user's network-connected device 10, preferably in the certificate store of the browser or operating system, and optionally to the Roaming Key Server 404. The public key and certificate are stored to the LDAP 401 or other suitable repository for the storage of public keys.

### Browser/Client Based Authentication

FIG. 3a illustrates a user authentication process whereby the server initiates the authentication process and by the user responding to the server authentication request.

A user associated with a network-connected device 10 signs in to a web application server 300, the web application server 300 optionally establishes an SSL/TLS session and which web application server 300 initiates a request to the user to authenticate. To facilitate user authentication, the web application server 300 generates a message, which in one embodiment of the invention is a random string that the web application server 300 may optionally sign and send the message to the user's network-connected device 10 which includes the browser/client application 20.

The browser/client application 20 receives the message and verifies the digital signature optionally associated with the web application server 300 message.

The user is then prompted by the browser/client application 20 to provide a password which if correct will release the user's private key and certificate from the browser or operating system key store on the user's network-connected device 10.

Upon the release of the private key the browser/client application 20 shall sign and encrypt the message for the server and send the signed message back to the client authentication Agent 405 or directly to the web application server 300. The browser/client application 20 can optionally decrypt the encrypted user authentication credentials stored in the extension field on the user's certificate and send the user authentication information to the authentication agent 405 or the web application server 300.

The authentication agent 405 or the web application server 300 receives, decrypts the message and verifies the digital signature associated with the message. If the digital signature is verified by the authentication agent 405 or the web application server 300, the user is verified and authenticated to use the web application server 300.

In one embodiment of the invention the authentication agent 405 or the application server 300 can optionally retrieve the user authentication credentials stored in the extension of the users certificate or receive the user authentication credentials sent by the browser/client application 20 and, if encrypted for the authentication agent 405 or the web application server 300, decrypt the user credentials. Upon the successful retrieval and optional decryption, the user credentials are presented by the authentication agent 405 to the web application server 300 or directly to the web application server 300, and the user credentials are verified and authenticated to provide access to the web application server 300. The purpose of the separate user credentials is to facilitate the support of existing applications such that this approach eliminates any requirement for change to any existing authentication systems associated with the web application server 300.

For the sake of clarity, it should be understood that in particular embodiments of the present invention, the authentication agent 405 operates between the web application server 300 and the browser/client application 20, where the operator of the web application server 300 desires to maintain its current processes or security infrastructure. For example, in the case of a financial institution, a bank card and password would be presented to the authentication agent 405; the user would authenticate to the browser/client application 20 in accordance with one or more of the methods described in this invention; and thereby the authentication agent 405 confirms user authentication to the web application server 300. Accordingly, the financial institution maintains its existing processes and security infrastructure but benefits from the added trust and customer security provided by the present invention.

It should also be understood that FIGS. 3a, 3b, 3c, 3d, and 3e each illustrate variants of the method of the present invention. Specifically, each of these Figures illustrates ways in which trust is established between the browser/client application 20 and the web application server 300. In addition, the client authentication agent 405 can be utilized in association with each of such variants.

FIG. 3b illustrates a user authentication process whereby the server initiates the authentication process and by the user responding to the server authentication request by providing a cryptogram.

A user associated with a network connected device 10 signs in to a web application server 300, the web application server 300 optionally establishes optionally an SSL/TLS session and which web application server 300 initiates a request for the user to authenticate.

The browser/client application 20 receives the request for authentication and optionally verifies the web application server 300 based on establishing a secure session such as SSL/TLS with the web application server 300.

The user is then prompted by the browser/client application 20 to provide a password which if correct will release the user's private key and certificate from the browser or operating system key store on the user's network connected device.

Upon the release of the private key the browser/client application 20 shall create a message, optionally based on a standard established for the application, or based on a simple random string, then sign and encrypt the message for the server and send the signed message, what is called a cryptogram, back to the client authentication agent 405 or directly to the web application server 300. The browser/application 20 can optionally decrypt the encrypted user authentication credentials stored in the extension field on the user's certificate and send the user authentication information to the authentication agent 405 or the web application server 300 as part of the cryptogram.

The authentication agent 405 or the web application server 300 receives and decrypts the cryptogram and verifies the digital signature associated with the cryptogram. If the digital signature is verified by the authentication agent 405 or the web application server 300 the user or the user's transaction is verified and authenticated for the web application server 300. The purpose of a cryptogram is to facilitate the support of existing applications such that this approach eliminates any requirement for change to existing web application server 300 user or transaction authentication systems. Such applications include SET and 3-D Secure standards based payment processing systems for example

In one embodiment of the invention the authentication agent 405 or the web application server 300 can optionally retrieve the user authentication credentials stored in the extension of the user's certificate or receive the user authentication credentials sent by the browser/client application 22, and if encrypted for authentication agent or the web application server 300, decrypt the user credentials. Upon the successful retrieval and optional decryption, the user credentials are presented by the authentication agent 405 to the web application server 300 or directly to the web application server 300, and the user credentials are verified and authenticated to provide access to the web application server 300. The purpose of separate user credentials is to facilitate the support of existing applications such that this approach eliminates any requirement for change to existing web application server 300 user authentication systems.

FIG. 3c illustrates a user authentication process whereby the server initiates the authentication process and by the user responding to the server authentication request by authenticating and then establishing a two way SSL/TLS session.

A user associated with a network connected device signs in to the web application server 300, the web application server 300 optionally establishes a two-way SSL/TLS session and which browser/client application 20 initiates a request for the user to authenticate.

The browser/client application 20 receives the request to establish an SSL/TLS session and which verifies the web application server 300 SSL/TLS certificate.

The user is then prompted by the browser/client application 20 to provide a password which if correct will release the user's private key and certificate from the browser or operating system key store and establish a two way SSL/TLS session after which the authentication agent 405 confirms user authentication to the web application server 300 or is confirmed directly by the web application server 300.

In one embodiment of the invention, the authentication agent 405 or the web application server 300 can optionally retrieve the user authentication credentials stored in the extension of the user's certificate or receive the user authentication credentials sent by the browser/client application 20 and if encrypted for authentication agent 405 or the web application server 300 decrypt the user credentials. Upon the successful retrieval and optional decryption, the user credentials are presented by the authentication agent 405 to the web application Server 300 or directly by the web application Server 300 and the user credentials are verified and authenticated to provide access to the web application server 300. The purpose of separate user credentials is to facilitate the support of existing applications such that this approach eliminates any requirement for change to existing web application server 300 user authentication systems.

FIG. 3d illustrates a user authentication process whereby the user initiates the authentication process which causes the server to negotiate with the browser/client application 20 to establish a secure session which is used by the user to authenticate to the web application server 300.

A user associated with a network-connected device 10 “signs in” to initiate an authentication process which causes the server to negotiate in a manner which is known with the browser extension 309 to establish a secure session between the browser extension and the web application server 300 or authentication agent 405.

Upon the establishment of a secure session the user is prompted by the browser extension 309 to provide a password. The browser extension 309 relays the password via the secure session to the web application server 300 or authentication agent 405.

The authentication agent 405 confirms user authentication to the web application server 300 or is confirmed directly by the web application server 300.

In one embodiment of the invention the authentication agent 405 or the web application server 300 can optionally retrieve the user authentication credentials which can be stored in the extension of the user's certificate, or stored with the authentication agent 405 or receive the user authentication credentials sent by the browser/client application 20 and if encrypted for authentication agent 405 or the web application server 300, decrypt the user credentials. Upon the successful retrieval and optional decryption, the user credentials are presented by the authentication agent 405 to the web Application server 300 or directly by the web application server 300 and the user credentials are verified and authenticated to provide access to the web application server 300. The purpose of separate user credentials is to facilitate the support of existing applications such that this approach eliminates any requirement for change to existing web application server 300 user authentication systems.

FIG. 3e illustrates authenticating to the web application server 300 using one or more temporary and unpredictable code words for authentication either by presentation thereof in a web page or in a Java Applet, and optionally using a credential presentation agent (authentication agent 405) to authenticate to the web application server 300.

A user associated with a network connected device “signs in” to initiate an authentication process, which causes the web application server 300 to establish a secure SSL/TLS session between the browser and the web application server 300 or authentication agent 405.

Upon the establishment of a secure session, the user is prompted by the web application server 300 or the authentication agent 405 to answer a challenge question or to provide a temporary code word. The presentation of the request to answer a challenge question or to provide a temporary code word can be presented directly in the web page or in a Java Applet. The user inputs the answer or the code word to the browser extension 309, which in turn relays the answer or temporary code word via the secure session to the web application server 300 or authentication agent 405.

In one embodiment of the invention, the Java Applet can be used to access user PKC credentials from the Roaming Key Server 404 for use in the authentication process. Upon the provision of the one time code word or the answer to the random question, the authentication agent 405 confirms user authentication based on the answer or the code word or by authentication consisting of providing the user's PKC keys in the Java applet, to the web application server 300, or is confirmed directly by the web application server 300.

In one embodiment of the invention, the authentication agent 405 or the web application server 300 can optionally retrieve the user authentication credentials stored with the authentication agent 405 or web application server 300. Upon the successful retrieval and optional decryption, the user credentials are presented by the authentication agent 405 to the web application server 300, or directly by the web application server 300 and the user credentials are verified and authenticated to provide access to the web application server 300. The purpose of the separate user credentials is to facilitate the support of existing applications such that this approach substantially reduces or eliminates any requirement for change to existing authentication systems used at the web application server 300.

FIG. 3e is best understood as a further process of the present invention used in combination with one or more of the processes illustrated in FIGS. 3a, 3b, 3c, or 3d, whereby the process of FIG. 3e enables sign on to the web application server 300 from a mobile device.

It should be understood that the process illustrated in FIG. 3e is generally less secure than the processes illustrated in FIGS. 3a, 3b, 3c, or 3d but nonetheless enables protection against security attacks on user credentials between a mobile device and the web application server 300.

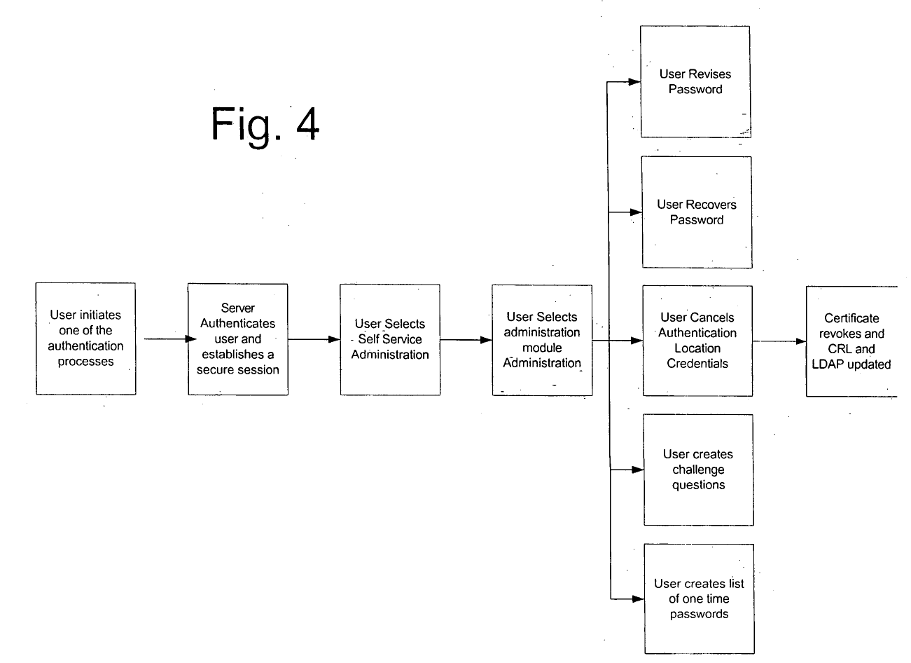

FIG. 4 illustrates user self-administration module where a user is able to perform credential administration functions.

As illustrated in FIG. 4 a user associated with a network-connected device 10 “signs in” to initiate an authentication process that causes the server to negotiate in one of the manners illustrated in FIGS. 3a, 3b, 3c, 3d, with the browser extension 309, or FIG. 3e with the browser to establish a secure session between the browser extension 309 or the browser and the web application server 300 or authentication agent 405.

Upon the authentication of the user and the establishment of a secure session the user accesses the Self-Administration Module 406. The Self-Administration Module 406 is designed to perform a number of caretaking tasks such as password revisions, password recovery, private key recovery, one time code word creation, challenge question and answer administration, location and certificate cancellation etc. Password revisions and password recovery are conducted in a manner which is well known. The significance of the Self-Administration Module 406 is that the user is empowered to administer important user authentication functions associated with the browser/client application 20, however, based on rules determined by the operator of the web application server 300, as s/he defines the browser/client application 20, including the specific aspects of the method of the present invention incorporated into the browser/client application 20 provided to the user. The Self-Administration Module 406, however, has the benefit of providing a degree of control to the user over its own security; and it reduces the administration costs of the operator of the web application server 300. The temporary code word can be generated by the user for mobility purposes such that the user can authenticate to the web application server 300 or the authentication agent 405 and request a list of one time code words for remote access to the web application server 300 or the authentication agent 405. When the application server generates the list, the user will print the list and carry it with them for remote access. Each time the user authenticates using a code word as illustrated in FIG. 3e the code word used is cancelled.

Another method illustrated in FIG. 3e would uses a series of challenge questions which would be created by the user at time of enrollment, through user self-service administration or such questions can be accessed from existing applications such as would be found in a telephone banking system for assisting customer service representatives to authenticate bank clients using a series of customer specific information. For mobile access the user will respond to a randomly chosen question, which if correctly answered, will grant access.

Another aspect of the invention illustrated in FIG. 4 allows users to cancel the user's authentication credentials and optionally user, location specific, user authentication credentials. The nature of the invention as illustrated in FIG. 3d enables the user to authenticate securely to an application from multiple locations. The present invention contemplates providing the user the ability to cancel location specific authentication credentials. Normally only single PKC keys pairs are issued to users. An aspect of the present invention will optionally allow multiple key pairs to be issued to users, one pair for each access location, thus allowing the user to cancel one location but continue to access the application server from another location. This aspect of the invention will allow the user, through the Self-service Module 406, to remotely disable authentication locations from authenticating to the web application server 300 regardless of whether the user's password is correctly used from that location. Such would be useful for situations such as when an employee is fired or otherwise terminates their employment.

It should be understood that the present invention enables the operator of the web application server 300 to control a series of user credential authentication processes by defining the processes embodied in the browser/client application 20 provided to the user. This creates social trust between the web application server 300 and the user. This social trust is consistent in any case with the expectations of users regarding the role of the operator of the web application server 300 in regard to protection from security attacks. This social trust also defeats a number of the Phishing techniques referred to above in that the key to a number of such techniques is that it is the user and not the web application server 300 that controls the authentication processes, such that it is somewhat easier for the Phisher to impose himself/herself between the user and the operator of the web application server 300. For example, in accordance with prior art security processes, it is the user's browser that determines whether or not to trust the web application server 300, not vice versa. The effect of this is that the user who is not as well placed to protect against security attacks as the operator of the web application server 300 is by default responsible for protecting against security attacks, including for example by determining whether a new version of a browser is required.

It should be also be understood that present invention provides a “virtual smart card” in the sense that the browser/client application 20 embodying the processes of the present invention enables security as between the user's network-connected device and the web application server 300 similar to that available via smart cards.

What is claimed is:

1. A method of protecting against one or more security attacks from third parties directed at obtaining user credentials on an unauthorized basis, as between a client computer associated with a user and a server computer, the client computer and server computer being connected to an interconnected network of computers, the method comprising the steps of:
(a) The server computer defining a trusted Public Key Cryptography utility for use on the client computer, the Public Key Cryptography utility being linked to a browser or a client communication program, or forming part of the browser or the client communication program, the Public Key Cryptography utility being operable to perform one or more cryptographic operations consisting of encrypting/decrypting data, authenticating data, and/or authenticating a sender, decrypting and/or verifying data;
(b) The user authenticating to the Public Key Cryptography utility, thereby invoking the accessing of user credentials associated with the user, as defined by the server computer;
(c) The Public Key Cryptography Utility facilitating the communication of the user credentials to the server computer, whether directly or indirectly via an authentication agent, the server computer thereby authenticating the user;
(d) In response to (c), the server computer providing access to one or more system resources linked to the server computer to the user.

2. The method of claimed in claim 1, comprising the further steps of:
(a) Downloading the Public Key Cryptography utility to the client computer; and
(b) Establishing a secure connection between the client computer and the server computer.

3. The method claimed in claim 2, comprising the further step of enrolling the user by the user providing the answer to a predetermined challenge question to the Public Key Cryptography utility on a secure basis, thereby initiating the Public Key Cryptography utility to authenticate the user to the server computer, whether directly or indirectly via an authentication agent.

4. The method claimed in claim 1, whereby the Public Key Cryptography utility initiates a secure connection with the server computer for communicating the user credentials.

5. The method of claim 1, comprising the further step of the server computer administering the user credentials of a plurality of users by assigning or revoking the user credentials of particular users.

6. The method of claim 5, whereby the server computer defines a series of user credentials for a single user, whereby each of such user credentials is operable to authenticate the user to the server computer one time only.

7. The method of claim 1, whereby the server computer authenticates the user by:
(a) The user logging on to the server computer;
(b) The server computer initiating a request to the user to authenticate, by sending a communication to the client computer, the communication being cryptographically signed;
(c) In response to the communication, the Public Key Cryptography utility prompting the user to provide a password, which if correct the user's private key and certificate is released to the user;
(d) The Public Key Cryptography utility signing and encrypting a communication using the private key and the certificate, which communication is sent to the server computer;
(e) The server computer decrypting the communication referred to in (d), and verifying the associated signature; and
(f) If the associated signature if verified, the server computer authenticating the user.

8. The method of claim 1, whereby the server computer authenticates the user by:
(a) The user logging on to the server computer;
(b) The server computer initiating a request to the user to authenticate, which is received by the Public Key Cryptography utility;
(c) In response to (b), the Public Key Cryptography utility verifying the server computer by establishing a secure session between the client computer and the server computer;
(d) In response to the communication, the Public Key Cryptography utility prompting the user to provide a password, the user providing the password, which if correct the user's private key and certificate is released to the user;
(e) The Public Key Cryptography utility creating a cryptogram consisting of a message that is signed and encrypted for the server computer, and sending the cryptogram to the server computer;
(f) The server computer receiving the cryptogram, decrypting the cryptogram and verifying a digital signature associated with the cryptogram; and
(g) If the associated digital signature is verified, the server computer authenticating the user.

9. The method claimed in claim 4, comprising the further steps of:
(a) Establishing a certificate for authenticating the user from an additional client computer associated with the user, or a second computer, such second computer not being linked to the Public Key Cryptography utility, the certificate embedding the user credentials in an encrypted form, and storing the certificate to a browser loaded on the second computer;
(b) The user logging on to the server computer from the second computer;
(c) The server computer initiating a request to the second computer to authenticate the user and to establish a secure session between the server computer and the second computer;
(d) In response to the request of (c), the user providing a password to the browser, the browser thereby accessing the certificate and releasing the certificate to the server computer in the secure session; and
(e) The server computer decrypting the embedded user credentials, and authenticating the user based on the user credentials.

10. The method claimed in claim 9, whereby the user credentials are encrypted in the certificate with a private key associated with the operator of the server computer, and further encrypted with a private key associated with the user, whereby:
(a) The user initiates the decryption of the certificate based on the user's private key, which is accessible to the browser;
(b) Releasing the decrypted user credentials to the server computer in the secure session; and
(c) The server computer further decrypting the user credentials based on the server computer's private key.

11. The method claimed in claim 1, whereby the server computer authenticates the user by:
(a) The user logging on to the server computer;
(b) The client computer initiating a request to the server computer for the server computer to authenticate the user;
(c) In response to (b), the server computer establishing a secure session with the Public Key Cryptography utility;
(d) Prompting the user to provide a password, and passing the password to the server computer in the secure session; and
(e) In response to (d), the server computer authenticating the user;
Whereby the method enables the user to authenticate to the server computer from multiple client computers associated with the user.

12. The method claimed in claim 11, comprising the further steps of:
(a) The user initiating authentication of the user by the server computer; and
(b) The user accessing a self-administration facility linked to the server computer, the self-administration facility enabling the user to revoke its user credentials for authentication of the user from one or more of the multiple client computers associated with the user, thereby terminating the ability to authenticate to the server computer from that particular client computer.

13. The method claimed in claims 7, comprising the further step of:
(a) The user obtaining from the server computer one or more passwords that enable one time authentication of the user from a wireless device, the one or more passwords enabling the user to access the one or more system resources linked to the server computer.

14. The method claimed in claim 13, whereby the one or more passwords are either:
(a) Defined by the server computer based on information regarding the user mined from a database linked to the server computer; or
(b) Defined by the user on the server computer on a secure basis.

15. The method claimed in claim 1, whereby an authentication agent is linked to the server computer, the authentication agent acting as an intermediary between the client computer and the server computer, whereby the user authenticates to the authentication agent, and in response to such authentication enables the client computer to access the one or more system resources linked to the server computer, and whereby the operation of the authentication agent protects against one or more security attacks from third parties directed at obtaining user credentials on an unauthorized basis without requirement of any change in security processes or architecture at the server computer.

16. A server computer program for use on a server computer, for protecting against one or more security attacks from third parties directed at obtaining user credentials on an unauthorized basis as between a client computer associated with a user, and a server computer, the client computer and server computer being connected to an interconnected network of computers, the server computer program comprising computer instructions for defining on the server computer:
(a) An enrolment utility that is operable to define a Public Key Cryptography utility, the Public Key Cryptography utility being operable to enable the users to authenticate to the server computer, the enrolment utility being operable to define a plurality of authentication rules that define the method by which the Public Key Cryptography utility enables the authentication of the users to the server computer; and
(b) An authentication utility, which is operable to cooperate with the various Public Key Cryptography utilities associated with the users to authenticate the users to the server computer, and thereby enable the users to access one or more system resources linked to the server computer.

17. The server computer program claimed in claim 15, the server computer program being operable to facilitate the users downloading the Public Key Cryptography utility.

18. The server computer program claimed in claim 15, the server computer program further defining on the server computer a self-administration facility enabling the users to revoke one or more of their user credentials, including user credentials defined by the server computer for one particular client computer, thereby terminating the ability to authenticate to the server computer from that particular client computer.

19. A computer system for protecting against one or more security attacks from third parties directed at obtaining user credentials on an unauthorized basis as between one or more client computers associated with one or more users and a server computer, the client computers and the server computer being connected to an interconnected network of computers, the computer system comprising:
(a) A server computer linked to a database; and
(b) A server computer program defining on the server computer:
(i) An enrolment utility that is operable to define a Public Key Cryptography utility, the Public Key Cryptography utility being operable to enable the users to authenticate to the server computer, the enrolment utility being operable to define a plurality of authentication rules that define the method by which the Public Key Cryptography utility enables the authentication of the users to the server computer; and
(ii) An authentication utility, which is operable to cooperate with the various Public Key Cryptography utilities associated with the users to authenticate the users to the server computer, and thereby enable the users to access one or more system resources linked to the server computer.

20. A computer program for use on a client computer associated with a user registered to access system resources linked to a server computer, the computer program comprising computer instructions for defining on the client computer a Public Key Cryptography utility wherein:
(a) The Public Key Cryptography utility being linked to a browser or a client communication program, or forming part of the browser or the client communication program, the Public Key Cryptography utility being operable to perform one or more cryptographic operations consisting of encrypting/decrypting data, authenticating data, and/or authenticating a sender, decrypting and/or verifying data; and
(b) The Public Key Cryptography utility enabling the user to authenticate to the server computer, Public Key Cryptography utility embodying a plurality of authentication rules established by the server computer that define the method by which the Public Key Cryptography utility enables the authentication of the users to the server computer.

21. A computer system for protecting against one or more security attacks from third parties directed at obtaining user credentials on an unauthorized basis as between a client computer associated with a user, and a server computer, the client computer and server computer being connected to an interconnected network of computers, the computer system comprising:
(a) A computer; and
(b) A computer program linked to the computer, the computer program defining a Public Key Cryptography utility wherein:
(i) The Public Key Cryptography utility being linked to a browser or a client communication program, or forming part of the browser or the client communication program, the Public Key Cryptography utility being operable to perform one or more cryptographic operations consisting of encrypting/decrypting data, authenticating data, and/or authenticating a sender, decrypting and/or verifying data; and
(ii) The Public Key Cryptography utility enabling the user to authenticate to the server computer, Public Key Cryptography utility embodying a plurality of authentication rules established by the server computer that define the method by which the Public Key Cryptography utility enables the authentication of the user to the server computer.
